(19) United States
(12) Patent Application Publication
(10) Pub. No.: US 2008/0140407 A1
(43) Pub. Date: Jun. 12, 2008

(54) Speech synthesis

(75) Inventors: Matthew Peter Aylett, Midlothian (GB); Christopher John Pidcock, Midlothian (GB)

Correspondence Address: HARRINGTON & SMITH, PC, 4 RESEARCH DRIVE, SHELTON, CT, 06484-6212, US

(73) Assignee: Cereproc Limited

(21) Appl. No.: 11/706,770

(22) Filed: Feb. 15, 2007

(30) Foreign Application Priority Data
Dec. 7, 2006 (GB) 0624474.3

(51) Int. Cl. G10L 13/00

(52) U.S. Cl. 704/260

(57) ABSTRACT

A method of controlling production of an aural advertisement including: enabling user adaptation of audio features that are associated with advertising copy text in a display; and creating a speech synthesizer command dependent upon a textual content of the advertising copy text and the adapted audio features that controls a voice synthesizer to produce an aural advertisement.

### FIELD OF THE INVENTION

Embodiments of the present invention relate to speech synthesis. In particular embodiments of the invention relate to enabling users who are not experts at speech synthesis to control the production of synthesized speech.

### BACKGROUND TO THE INVENTION

Recordings of speech have many uses. For example an answer phone may require a short section of speech to welcome a caller, another perhaps to say a caller is away at a meeting and when they will be back. The amount of speech sections required for a device varies from a few, in a device such as an answer phone, to hundreds in a call centre application to possibly thousands in an interactive computer game.

Recording good quality speech is expensive and often impossible for small enterprises or individuals who cannot afford a recording studio and pay an experienced voiceover artist.

A speech synthesis system can be used to create speech. However, the way a sentence is produced by the speech synthesis system may not match a user's requirements. In a recording studio environment the voiceover artist can be instructed to produce the speech section differently. For synthetic speech, techniques do exist to modify the way the speech is produced but they are complex and require an experienced engineer or phonetician to set the input parameters to the algorithms.

It would therefore be desirable to provide a technical solution that enables unskilled users to prepare and modify synthetic speech.

It would be desirable to provide new applications for speech synthesis by enabling unskilled users to prepare and modify synthetic speech.

### BRIEF DESCRIPTION OF THE INVENTION

According to some embodiments of the invention there is provided a method of controlling production of an aural advertisement comprising: enabling user adaptation of audio features that are associated with advertising copy text in a display; and creating a speech synthesizer command dependent upon a textual content of the advertising copy and the adapted audio features that controls a voice synthesizer to produce an aural advertisement.

According to some embodiments of the invention there is provided an apparatus comprising: a display for displaying advertising copy text; a user input device for adapting audio features that are visually associated with the advertising copy text; a processor for creating voice synthesizer commands that depend upon the advertising copy text and the adapted audio features; and an audio output device for outputting speech synthesized by a voice synthesizer.

According to some embodiments of the invention there is provided a control interface for controlling production of an aural advertisement comprising: a display for displaying a advertising copy text; and a user input device for adapting audio features that are associated with the advertising copy text; and means for creating voice synthesizer commands that depend upon the advertising copy text and also the adapted audio features.

According to some embodiments of the invention there is provided a method of manufacturing an aural advertisement comprising: receiving advertising copy; and performing speech synthesis of the advertising copy to produce a data structure that is operable to control an audio device to render the advertising copy as synthesized speech.

Embodiments of the invention allow novices to produce high quality audio using text to speech synthesis.

According to some embodiments of the invention there is provided a method of controlling text to speech synthesis comprising: enabling user adaptation of a presentation of text in a display; creating a speech synthesizer command that depends upon a text content and also upon the presentation of the text and that controls a voice synthesizer to produce synthesized speech that renders the text as speech with characteristics that are dependent upon the presentation of the text.

The presentation of text may be dependent upon the visual appearance of the text and independent of any characters used to form the text. The text may comprise phrases and the visual appearance of the text may be dependent upon the visual appearance of each phrase. The visual appearance of a phrase may be dependent upon one or more of typeface, size of typeface, positioning of text, and orientation of text.

A presentation of text may be dependent upon the presence of flags in association with the text.

The characteristics of synthesized speech may include amplitude, speech rate, pitch and intonation.

The speech synthesizer command may control audio features of the synthesized speech.

The speech synthesizer command may constrain operation of the speech synthesizer.

The text may be comprised of phrases, the speech synthesizer command forcing an alternative rendition of at least one phrase within the text.

The text may be comprised of phrases, a command forcing a particular rendition of at least one phrase within the text.

The speech synthesizer command may mandate a particular audio feature in the synthesized speech.

The speech synthesizer command may comprise mark up text.

The method may further comprise: receiving from the voice synthesizer mark up text representing synthesized speech; converting the mark up text into a particular presentation of the text that represents the synthesized speech and its characteristics; and displaying the particular presentation of the text for user adaptation.

The method may further comprise: producing synthesized speech that renders the text as speech with characteristics that are dependent upon the presentation of the text.

The text may comprise phrases, the method further comprising adapting a presentation of the text in the display by independently adapting the presentation of individual phrases.

The method may enable a user to adapt automatically and simultaneously the presentation of multiple independent phrases within the text.

According to some embodiments of the invention there is provided a method of controlling the rendering of text as audio using speech synthesis comprising: displaying text with a first presentation; creating a first command that depends upon the first presentation and controls a voice synthesizer to produce first synthesized speech that renders the text and that has first characteristics; enabling user adaptation of the presentation of text to form a second, different, presentation of the same text; creating a second, different, command that depends upon the second presentation of the text and controls the voice synthesizer to produce second synthesized speech that renders the text and that has second characteristics at least some of which are different to the first characteristics.

According to embodiments of the invention there is provided an apparatus for controlling text to speech synthesis comprising: a display for displaying a presentation of text; a user input device for adapting the presentation of text; a processor for creating voice synthesizer commands that depend upon the text and also the presentation of the text; and an audio output device for outputting speech synthesized by the voice synthesizer in response to voice synthesizer commands.

The user input may be arranged to adapt a presentation of text by varying, for phrases within the text, one or more of a typeface type used for a phrase, a size of typeface used for a phrase, a position of a phrase relative to other phrases and an orientation of a phrase.

The text may comprise phrases, the user input enabling a user to adapt a presentation of text by independently adapting the presentation of individual phrases.

The user input may be arranged to adapt a presentation of a phrase by applying one or more flags to the phrase

A voice synthesizer command may control characteristics of the synthesized speech A voice synthesizer command may control operation of the speech synthesizer.

A voice synthesizer command may forces one or more alternative renditions of at least one phrase within the text, a particular rendition of at least one phrase within the text and digital signal processing at the speech synthesizer.

The voice synthesizer command may comprise mark up text.

The apparatus may be arranged to control the display to display the text with a particular presentation, for user adaptation, that represents synthesized speech output by the output device.

According to embodiments of the invention there is provided a control interface for text to speech synthesis comprising: a display for displaying a presentation of text; and a user input device for adapting the presentation of text; and means for creating voice synthesizer commands that depend upon the text and also the presentation of the text.

The user input device may be arranged to adapt a presentation of text by varying, for whole phrases within the text, one or more of a typeface type used for a phrase, a size of typeface used for a phrase, a position of a phrase relative to other phrases and an orientation of a phrase.

The text may comprise phrases, the user input enabling user adaptation of the presentation of the text on a phrase by phrase basis only.

According to embodiments of the invention there is provided a computer program product comprising computer program instructions which when loaded into a processor control the processor to enable user adaptation of a presentation of displayed text; and automatic creation of voice synthesizer commands that depend upon a content of displayed text and also the presentation of the displayed text.

According to embodiments of the invention there is provided a speech synthesizer comprising: an input for receiving speech synthesis commands; a synthesizer for performing speech synthesis to produce synthesized speech based upon the received speech synthesize commands; and an output for providing a text based description of the produced synthesized speech.

The speech synthesizer may further comprise an interpreter for interpreting received speech synthesis commands to identify specified audio features for the synthesized speech and identify constraints on the synthesis process.

The synthesizer process may include unit selection, the synthesizer constraining a result of the synthesis process by mandating the selection of units specified in a speech synthesis command.

The synthesizer process may include unit selection, the synthesizer constraining a result of the synthesis process by preventing the selection of specific units in the result.

The synthesizer may constrain a result of the synthesis process by mandating that audio features specified in a speech synthesis command are included in a result of a synthesis process. The synthesizer process may include unit selection, the synthesizer performing digital signal processing to achieve the specified audio features if they cannot be obtained by unit selection.

According to embodiments of the invention there is provided a speech synthesizer comprising: an input for receiving speech synthesis commands; a synthesizer for performing speech synthesis to produce synthesized speech based upon the received speech synthesize commands; and an interpreter for interpreting received speech synthesis commands to identify specified audio features for the synthesized speech and constraints on the synthesis process.

### BRIEF DESCRIPTION OF THE DRAWINGS

For a better understanding of the present invention reference will now be made by way of example only to the accompanying drawings in which:

FIG. 1 schematically illustrates an apparatus for controlling text to speech synthesis for which the speech synthesizer is local;

FIG. 2 schematically illustrates an apparatus for controlling text to speech synthesis for which the speech synthesizer is remote;

FIG. 3A illustrates a presentation of text before user adaptation;

FIG. 3B illustrates a new presentation of text, after the presentation illustrated in FIG. 3A has been adapted by a user;

FIG. 4A illustrates a presentation of text before user adaptation

FIG. 4B illustrates a new presentation of text, after the presentation illustrated in FIG. 4A has been adapted by a user;

FIG. 5 illustrates a presentation of text after user adaptation;

FIG. 6 illustrates a mapping between presentation parameters and respective acoustic effects of the presentation parameters on speech synthesis;

FIG. 7 schematically illustrates a method of controlling text to speech synthesis;

FIG. 8 schematically illustrates a text-to-speech synthesizer;

FIG. 9 illustrates a main editing window of a different embodiment in which speech characteristics of synthesized text are controlled by user selection of selectable options positioned adjacent the text; and

FIG. 10 illustrates a pronunciation window for accessed via the main editing window of FIG. 9.

### DETAILED DESCRIPTION OF EMBODIMENTS OF THE INVENTION

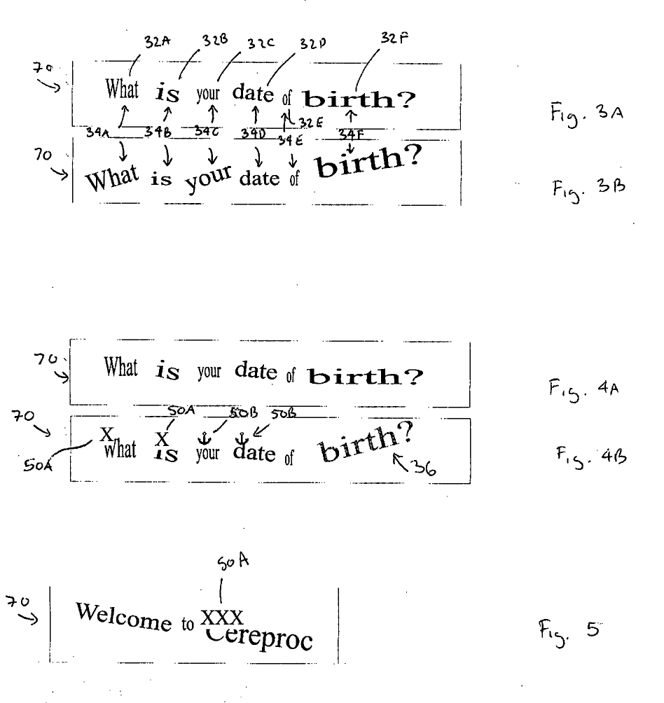

Some embodiments of the present invention provide a graphical user interface (GUI) that enables intuitive user control of text to speech synthesis. The GUI allows a user to vary how text is synthesized by adapting the presentation of that text. By adapting the presentation of text a user is thus able to manually intervene in automatic speech synthesis of that text. FIGS. 3A, 3B, 4B and 5 illustrate different presentations of the same text 70 and each different presentation controls a different synthesis of the text. The presentation of text is independent of the content of the text i.e. the particular arrangement of characters used. It relates to how the text looks and not what it says.

Different presentation features (defined by presentation parameters) result in different speech synthesis control and FIG. 6 illustrates an example of how different presentation parameters may be mapped to different speech synthesis characteristics.

The GUI enables the complex control of synthesis required to produce desired synthetic speech to be carried out by a user who has no technical background in speech synthesis and speech technology.

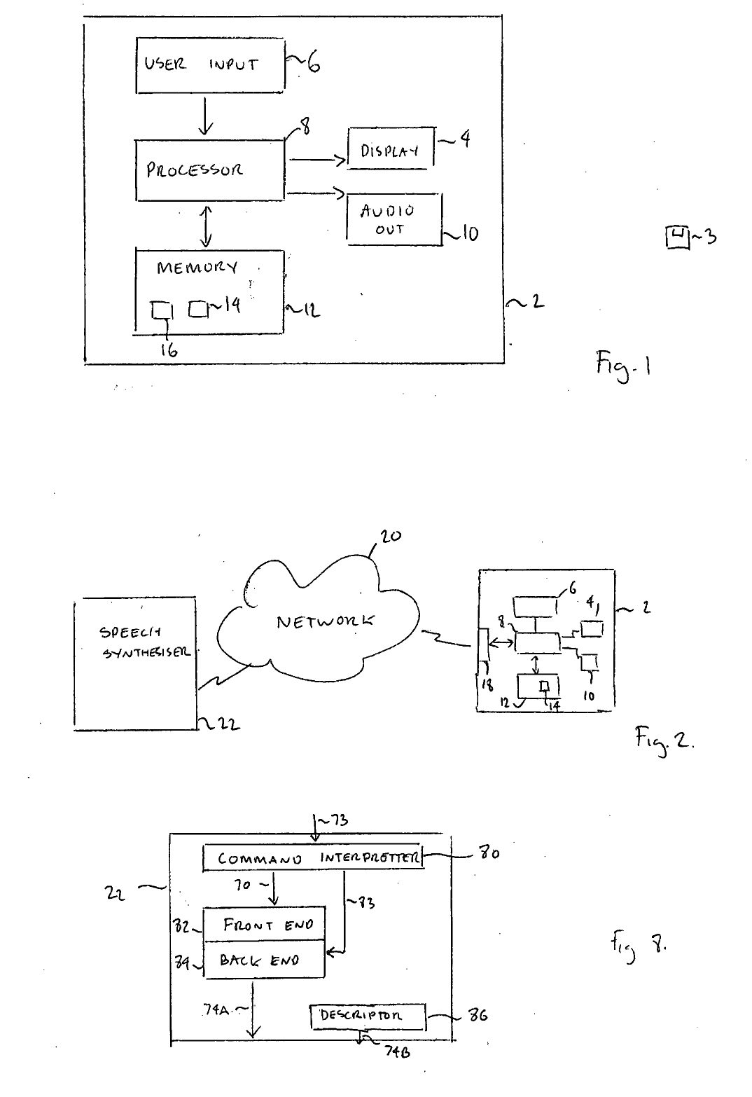

FIG. 1 schematically illustrates an apparatus 2 for controlling text to speech synthesis and providing the GUI. The apparatus 2, in this example, comprises a display 4 for displaying a presentation of text 70; a user input device 6 for adapting the presentation of text 70; a processor 8 for creating voice synthesizer commands that depend upon the text and also the presentation of the text; and an audio output device 10 for outputting speech synthesized by the voice synthesizer.

The processor 8 is arranged to receive input control signals from the user input device 6, which may be, for example, a computer mouse, a keyboard etc and the processor 8 is arranged to provide output control signals to the display 4 and also to the audio output device 10. The processor 8 is also arranged to read from and write to a memory 12.

The memory 12 stores a computer program 14 which when loaded into the processor 8 enables the processor 8 to perform steps in the method illustrated in FIG. 7. The programmed processor 8 provides command means for creating voice synthesizer commands 73 that depend upon the text 70 in the display 4 and also upon the presentation of the text 70 in the display. This command means in combination with the display 4 and user input device 6 provides a control interface via the GUI for text to speech synthesis.

The computer program 14 may arrive at the apparatus 2 via an electromagnetic carrier signal that may be temporarily stored in a memory buffer or be copied from a physical entity 3 such as a computer program product, a memory device or a record medium such as a CD-ROM or DVD.

The apparatus 2 in this example has software 16 which when loaded in the processor 2 provides a text-to-speech synthesizer. In other examples, a dedicated text-to-speech synthesizer 22 may be provided in the apparatus. In other examples, a text-to-speech synthesizer 22 may be located remotely from the apparatus 2 as illustrated in FIG. 2.

In FIG. 2, the apparatus 2 is substantially as described in relation to FIG. 1 except the memory 12 does not store text-to-speech synthesis software 16 and the apparatus 2 further comprises a network adapter 18, connected to processor 8, that enables the apparatus 2 to communicate with a remote speech synthesizer 22 via a network 20. The network 20 is preferably a packet-switched network such as the Internet.

The text content ‘What is your date of birth?’ is illustrated with different presentations 30 in FIGS. 3A, 3B, 4A, 4B and 5. The text 70 is comprised of phrases (e.g. words) 32. The presentation 34 of each phase 32 may be defined by a set of presentation parameters that are separately and independently adjusted by a user using the user input device 6.

The user adjustable presentation parameters for a phrase 32 include its typeface, its font size, its position in a transverse direction relative to other phrases, the orientation of the phrase, the presence of different flags.

There is an intuitive mapping between presentation parameters for a phrase 32 and the speech characteristics of that phrase when it is rendered as a synthetic speech utterance. An example of such a mapping is illustrated in FIG. 6.

The mapping of presentation parameters for a phrase to speech characteristics for that phrase enables a user without knowledge of the complex language required to control a speech synthesizer directly to control the text-to-speech synthesis.

FIG. 6 illustrates a mapping 40 presented as a table. The first column of the table comprises presentation parameters 42. The second column describes the respective effects of the presentation parameters, when applied to a phrase, on the speech characteristics of that phrase when synthesized.

The presentation parameters 42 include a first set of presentation parameters 42A that relate to the visual appearance of a phrase and, in particular, the visual appearance of the characters of the phrase. They include, for example, typeface size, transverse position, orientation and character spacing. This first set of presentation parameters 42A, when applied to a phrase, specifies audio features for the synthesized speech when that phrase is synthesized. The audio features include amplitude, pitch, intonation and speech rate. In this example, font height is related to amplitude, font length to speech rate, transverse position (height on the page) to pitch, orientation to intonation- upwards to indicate rising pitch, downwards to indicate falling pitch.

The presentation parameters 42 include a second set of presentation parameters 42B that identify flags 50 that can be visually applied to a phrase. They include, for example, an ‘alternative’ flag 50A and a ‘fixed’ flag 50B. This second set of presentation parameters 42B, when applied to a phrase, specifies constraints on the operation of the speech synthesizer 22. The alternative flag 50A, which is this example is a small graphic symbol such as a cross or skull and crossbones, when associated with a phrase requires a different rendition for that phrase by the speech synthesizer than a previous rendition of that phrase by the speech synthesizer. The fixed flag 50B, which is this example is a small graphic symbol such as an anchor or padlock, when associated with a phrase requires that the same rendition for that phrase by the speech synthesizer as the previous rendition.

Font colour may be used to mark how strongly a user has a preference for a specific change. The color red (grey in the figures) indicates the strongest preference.

The presentation parameters for a phrase are encoded as an XML code portion containing that phrase. The various XML code portions are concatenated to form an XML document which functions as a voice synthesizer command. Each XML code portion defines speech characteristics for the contained phrase.

The encoding of presentation parameters for a phrase as an XML code portion containing that phrase may use a new XML tag—the USEL tag. The attributes of the USEL tag are as follows:

| | Permitted | |
|---|---|---|
| Attribute | Values | Function |
| variant | 0–9 | This forces use of a specified synthesis version (i.e. 0 |
| | | means default, 1 means first alternative from the |
| | | default, 2 means second alternative from the default). |
| | | In the example of Figs this function is specified using one |
| | | or more alternative flag 50A. |
| force | TRUE/FALSE | If true the specified audio features for the synthesized |
| | | speech are forced to occur using digital signal |
| | | processing if unit selection cannot find the correct units. |
| | | In the example of Figs this function is specified using a |
| | | different color. |
| unit_ids | List of ids | Use these items in the database for synthesis rather |
| | (e.g. ‘pl p23 | than searching the database. This XML can only be |
| | p45’) | constructed automatically based on previous synthesis. |
| | | In the example of Figs this function is specified using a |
| | | fixed flag 50B. |

Commands for changes in amplitude, pitch and duration are translated into industry standard SSML XML using the SSML prosody tag.

Although XML has been described any mark-up which connects commands to text could be used.

FIG. 7 schematically illustrates method 50 for controlling text to speech synthesis. The figure illustrates the process when the speech synthesizer 22 and apparatus 2 are remote as illustrated, for example, in FIG. 2. However, the method 50 is also applicable if the speech synthesizer 22 is located within the apparatus 2 as illustrated, for example, in FIG. 1.

At step 51 text 70 is input to the apparatus 2. The text 70 may be entered either interactively using the user input device 6 or from a file.

Next at step 52, the text 70 is sent to the speech synthesizer 22. At step 53, the speech synthesizer performs text-to-speech synthesis producing results 70 which are sent to the apparatus 2 at step 54. The results 72 include a data structure 72A for rendering synthesized speech as an audio output and an XML document 72B that describes the rendered speech.

At step 55, the processor 8 of the apparatus 2 temporarily stores the received data structure 72A and the received XML document in the memory 12. The processor 8 uses the received data structure 72A to render synthesized speech via the audio output device 10. The processor 8 uses the received XML document 72B to display the text 70 on the display 4 with a presentation that corresponds to the rendered synthesized speech. The processor 8 identifies from the received XML document 72B the presentation parameters associated with each phrase in the text and adapts the presentation of a phrase on the display 4 to conform to the associated presentation parameters. The user can therefore listen to the synthesized speech and also simultaneously view a presentation of the text of the synthesized speech that represents the speech characteristics of the synthesized speech.

The user at step 56 decides whether the rendered synthesized speech is acceptable. If the user selects an option indicating that it is acceptable, the data structure 72A is saved in the memory 12 and the method 50 ends. If the user selects an option indicating that it is not acceptable, a cue editing process begins in which a user is able to modify the speech characteristics of phrases within the text.

A step 58, user adaptation of the presentation of the text 70 is enabled. The presentation parameters associated with a phrase 32 may be adjusted by selecting the phrase 32 and selecting from a list of presentation parameter options. Selecting a presentation option changes the presentation of the phrase in the display.

An expressive speech macro may be selected by a user to define a set of presentation parameters for a group of phrases. For example, an expressive speech macro may be used to convey emotions in the speech such as happiness and sadness. The happiness macro will define speech characteristics (and corresponding presentation parameters) that may increase pitch range, slightly increase the rate of speech and potentially add non standard XML tags used by the speech synthesis system to select more cheerful speech material over the entire series of phrases. The sadness macro will define speech characteristics (and corresponding presentation parameters) that may reduce pitch range, slow rate of speech and add non standard XML tags used by the speech synthesis system to select less cheerful speech material over the entire phrase. Neutral may be another macro.

When the user adaptation of the presentation of the text 70 is finished, at step 60, the processor 8 creates a speech synthesizer command 73 from the presentation parameters associated with the phrases of the text as described previously. The synthesizer command 73 is then sent to the speech synthesizer at step 61.

At step 62, the speech synthesizer performs text-to-speech synthesis producing results 74 which are sent to the apparatus 2 at step 63. The results 74 include a data structure 74A for rendering synthesized speech and an XML document 74B that describes the rendered speech.

At step 64, the processor 8 of the apparatus 2 temporarily stores the received data structure 74A and the received XML document 74B in the memory 12. The processor 8 uses the received data structure 74A to render synthesized speech via the audio output device 10. The processor 8 uses the received XML document 74B to display the text 70 on the display 4 with a presentation that corresponds to the rendered synthesized speech. The processor 8 identifies from the received XML document 74B the presentation parameters associated with each phrase 32 in the text 70 and controls the presentation 34 of a phrase 32 on the display 4 to conform to the associated presentation parameters. The user can therefore listen to the synthesized speech and also simultaneously view a presentation of the text 70 of the synthesized speech that represents the speech characteristics of the synthesized speech.

The method then returns to step 56. It will therefore be appreciated that a user may make many iterative changes to the synthesized speech. This has the advantages that a user can rectify mistakes or misjudgements easily and a user can enforce their preference for a speech characteristic if it is not provided by the speech synthesizer despite being requested.

FIGS. 3A and 3B shows an example of how a user may alter the font position and size to request a change to a phrase. FIG. 3A shows the text 70 having a presentation that corresponds to the synthesized speech rendered using the data structure 72A. The stress is on ‘is’ and ‘birth’ (large font size) with a dull falling intonation pattern. FIG. 3B shows a user modified version of the presentation of the text 70. The stress is now on ‘What’, ‘your’ and ‘birth’ with a cheerful rising intonation pattern.

FIG. 4A shows the text 70 having a presentation that corresponds to the synthesized speech rendered using the data structure 72A. The stress is on ‘is’ and ‘birth’ (large font size) with a dull falling intonation pattern. FIG. 4B shows the user using ‘preference functionality’ to modify the presentation of the text and control the operation of the speech synthesizer. ‘Birth’ is demanded to have a rising intonation. It is marked in red font 36 (shown as grey in the figure) indicating that the user is insisting that this rising intonation is applied even if poor synthesis results. The user is happy with the synthesis of ‘your date’ so fixes it with two fixed flags 50B. The user dislikes the synthesis for ‘what is’ and requests an unspecified alternative using a alternative flag 50A.

These changes would produce XML code in the speech synthesis command 73 in the following format:

```
<usel variant=‘l’>
    what is
</usel>
<usel unit_ids=‘p98 p789 p457 p9 p67 p1234’>
    your date
</usel>
<prosody contour=’ (O%,+5Hz) (IOO%,+20Hz)‘>
    <usel forcel=‘l’>
        birth
    </usel>
</prosody>
```

FIG. 4 shows an example of a user rejecting default synthesis. In this example the user has listened to 3 alternatives to the rendition of the proper name ‘Cereproc’ before finding a version they like. The three cross symbols are translated into XML code in the speech synthesis command of the following format:

welcome to<use1 variant=‘3’>cereproc</use1>

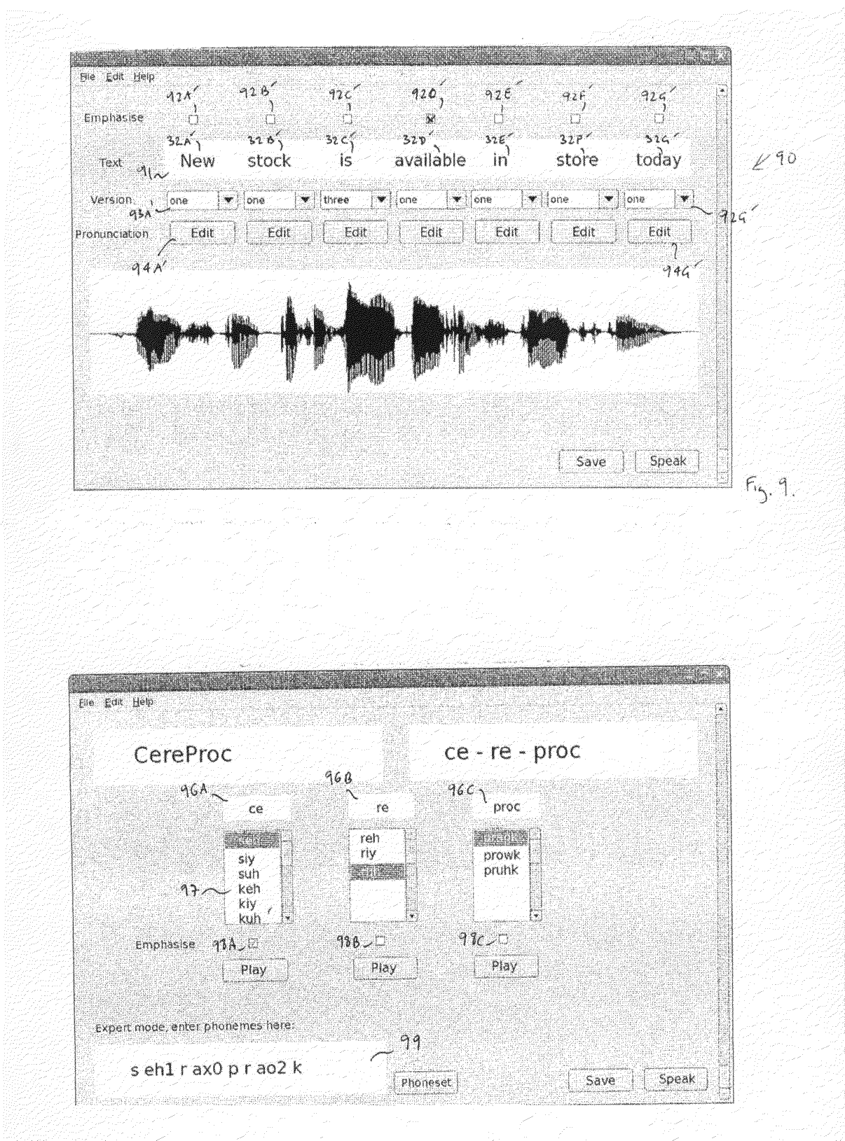

The speech synthesizer 22 may, as schematically illustrated in FIG. 8, comprise a number of functional blocks including a speech synthesis command interpreter 80, a descriptor unit 86 and a speech synthesis system having a front end 82 and a back end 84.

The speech synthesis command interpreter 80 receives and interprets speech synthesis commands 73. It extracts the text 70 from the speech command and provides it to the front-end 82. It also interprets the XML within a speech synthesis command to produce commands that control speech characteristics of the synthesized speech. These commands include user specified target audio features such as, for each phrase, one or more of the pitch, duration, amplitude, and units used (if this output is supported by the speech synthesis system) and, possibly, speech synthesis constraints that constrain the synthesis process.

At the front end 82 the text 70 is normalised and then split into phrases and then phonemes. A phrase is defined as a sequence of speech sounds surrounded by silence although the length of the silence could be very short, for example 5 milliseconds.

The back-end 84 receives the target audio features and the speech synthesis constraints from the speech synthesis command interpreter 80 and the phrases from the front-end 82. The back-end 84 uses an indexed database of speech sounds (units) from a recorded speaker or speakers. The units for a particular phoneme are indexed by their different speech characteristics such as pitch, intonation, amplitude etc.

The synthesis process uses unit selection from the indexed database. Unit selection synthesis works by taking the target audio features and a join or concatenation function which measures how well two sections of speech connect together. A database search is then carried out using the Viterbi algorithm to find the optimal sequence of speech chunks (units) that fulfill the target requirements AND join together well.

The back-end unit 84 provides as its output the data structure 74A representing the synthesized speech.

The descriptor unit 86 is connected to the back-end 84 of the speech synthesizer and it produces XML output 74B which describes how the synthesized speech has been realised in terms of pitch, amplitude, duration and units selected. The XML output 74B has the same format as speech synthesis commands 73.

Speech synthesis constraints are used to cope with the possibility that some target audio features may not be realised because either the required units do not exist in the database or units that satisfy the target audio features cannot be joined together well.

Certain XML code in a speech synthesis command 73 indicates that it is preferable for specific speech units to be used to synthesize a phrase typically because such units have been used before and the user has specified using the fixed flag 50B that the speech synthesis for that phrase should not change. An example of the XML code is:

<usel unit_ids=‘p98 p789 p457 p9 p67 p1234’>
your date
</usel>

In this example, the use1 unit_ids attribute specifies a set of units to use for ‘your date’. The back-end 84 of the speech synthesizer 22 may respond to receiving this command by pruning out all possible alternative units to the ones specified before unit selection for the text is performed.

Certain XML code in a speech synthesis command 73 indicates a strength of user preference concerning a particular target speech requirements. Typically, a specified target requirement is treated as desirable unless it is flagged 36 as mandatory. In the absence of suitable units digital signal processing should be used to interpolate and generate a suitable unit. The digital signal processing may be used, for example, to alter amplitude, pitch duration for a unit to enable the target speech requirements to be met. An example of the XML code is:

```
<prosody contour=‘ (O%,+5Hz) (IOO%,+20Hz)’>
    <usel force=‘l’>
        birth
    </usel>
</prosody>
```

The SSML prosody tag requests that the pitch in ‘birth’ is raised and is higher still towards the end. The usel force attribute instructs the back-end 84 of the speech synthesis system to use a corresponding unit if available or if a corresponding unit is not available to generate units using digital signal processing techniques that force this pitch rise.

Certain XML code in a speech synthesis command indicates that it is preferable for specific renditions of a phrase not to be used. This code corresponds to the alternate flag 50A. An example of the XML code used to flag a phrase in this way is:

<usel variant=‘l’>
what is
</usel>

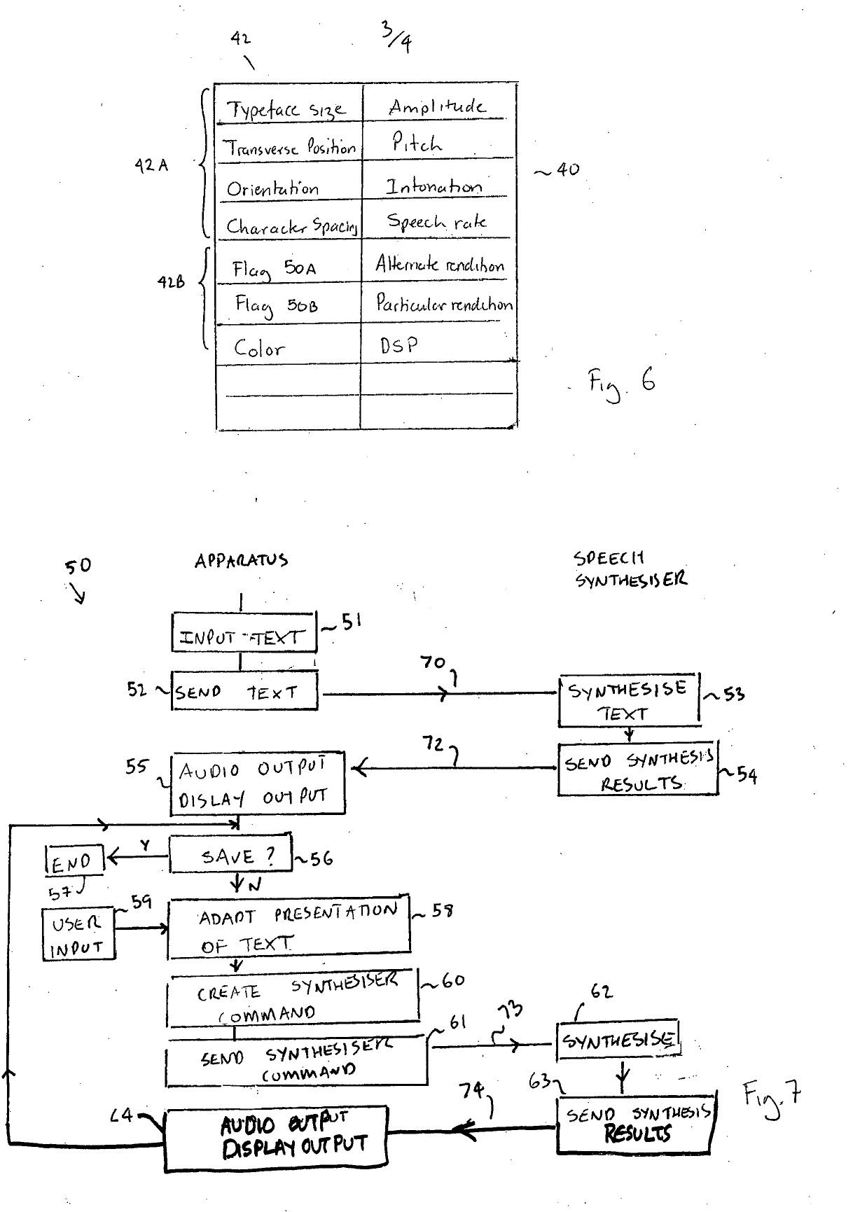

This flag instructs the back-end speech synthesis system to prune out, after an initial unit selection search, the first unit selection for ‘what is’ and carry out the search again. Re-synthesis occurs N times where N is the value of the variant attribute. It occurs once for ‘what is’ of FIG. 4B and three times for ‘Cereproc’ of FIG. 5). Each time the selected units are pruned out and the synthesis repeated.

One application for the apparatus 2 is as an advertisement creation apparatus.

This is a useful practical application in that the apparatus 2 enables an unskilled user to produce an aural advertisement without having to hire and direct a voice artist. The results of the invention are an advertisement that has been produced at lower cost. The invention therefore represents a technical improvement to a manufacturing process and is a tangible invention.

The apparatus 2 illustrated in FIG. 1 is capable of controlling the manufacture or production of an aural advertisement and also capable of manufacturing the aural advertisement. The apparatus 2 illustrated in FIG. 1 is capable of controlling the manufacture or production of an aural advertisement and the remote speech synthesizer 22 is capable of manufacturing the aural advertisement.

At the apparatus 2, the display 4 displays the advertising copy text 70. A user input device is used to adapt audio features that are visually associated with the advertising copy text 70.

Audio features may be visually associated with the advertising copy text 70 as previously described with reference to FIGS. 3A, 3B, 4A, 4B and 5 namely via the presentation of the text. In this case, audio features are adapted by adapting the presentation of the text as described above.

Audio features may alternatively be visually associated with the advertising copy text 70 as described below with reference to FIGS. 9 and 10 namely using explicit user selectable options that are positioned adjacent the text. In this case, audio features are adapted by changing the selected options as described below.

The processor 8 creates voice synthesizer commands 73 that depend upon the advertising copy text and the adapted audio features (step 60 of FIG. 7).

The voice synthesizer 22, in response to the speech synthesizer command 73 including advertising copy text, produces synthesized speech encoded in a data structure 74A (step 62 of FIG. 7). The speech synthesizer thus manufacturers an aural advertisement.

The data structure 74A is stored in memory 12 by processor 8 and is then processed by the processor 2 which then controls the audio output device 10 to render the advertising copy as synthesized speech (step 64 of FIG. 7).

The display 4, user input device 6 and processor 8 in combination provide a control interface for controlling the production of an aural advertisement that enables a user to easily produce speech synthesizer commands that depend upon the advertising copy text and also user adapted audio features.

As an alternative to adapting audio features by adapting a presentation of displayed text, it is possible to adapt audio features associated with the text of the advertising copy as illustrated in FIGS. 9 and 10.

FIG. 9 illustrates a main editing window of the control interface 90. The text 70 is displayed (unformatted) in window 91. It includes phrases (e.g. words) 32 and each phrase 32 has an associated adjacent emphasise option 92, a version number option 93 and an edit option 94.

The audio features for a phrase 32N are controlled by selecting one or more of the options 92N, 93N or 94N associated with that phrase.

Selecting the emphasise option 92 for a phrase has the equivalent effect of increasing the font size in the embodiments illustrated in FIGS. 3-5. It indicates that when this phrase is synthesized it should be synthesized with increased amplitude.

Selecting the Mth version number 93 for a phrase has the equivalent effect of marking the phrase with M ‘alternative’ flags 50A in the embodiments illustrated in FIGS. 3-5. It indicates that this phrase should be synthesized M times, with the combination of units selected during synthesis of the phrase being prevented from being selected in subsequent re-synthesis.

Selecting the edit option 94 associated with a phrase opens a pronunciation window 95 for the phrase as illustrated in FIG. 10. This window identifies the syllables 96 of the phrase and it allows a user to scroll and select, for individual syllables, alternative phonemes 97. It also allows a user to select options 98 for emphasising individual syllables. A play option is provided for each syllable so that a user can understand the effect of any adaptation to the audio features of the syllable.

A text input window 99 is also provided where an expert user can explicitly enter phonemes.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method of controlling production of an aural advertisement comprising:
enabling user adaptation of audio features that are associated with advertising copy text in a display; and
creating a speech synthesizer command dependent upon a textual content of the advertising copy text and the adapted audio features that controls a voice synthesizer to produce an aural advertisement.

2. A method as claimed in claim 1 implemented using a computer.

3. A method as claimed in claim 1, further comprising storing in a memory a data structure for rendering the aural advertisement.

4. A method as claimed in claim 1, wherein the audio features are adapted by user adaptation of a presentation of the advertising copy text.

5. A method as claimed in claim 1, wherein the audio features are adapted by user selection of options presented adjacent the advertising copy text.

6. A method as claimed in claim 1, further comprising producing the aural advertisement by rendering the advertising copy text as speech having characteristics that are dependent upon the presentation of the text of the advertising copy.

7. A method as claimed in claim 6, wherein characteristics of synthesized speech include amplitude, speech rate, pitch and intonation.

8. A method as claimed in claim 1, wherein the step of enabling user adaptation of audio features that are associated with advertising copy text in a display involves enabling user adaptation of a presentation of the advertising copy text in a display, and wherein the speech synthesizer command depends upon the textual content of the advertising copy and also upon the presentation of the advertising copy text and wherein the aural advertisement renders the text as speech with characteristics that are dependent upon the presentation of the advertising copy text.

9. A method as claimed in claim 8, wherein the advertising copy text comprises phrases and the presentation of the advertising copy text is dependent upon the visual appearance of each phrase and the visual appearance of a phrase is independent of the visual appearance of another phrase but dependent upon one or more of typeface, size of typeface, positioning of text, and orientation of text.

10. A method as claimed in claim 9, further comprising receiving from the voice synthesizer mark up text representing synthesized speech; converting the mark up text into a particular presentation of the text that represents the synthesized speech and its characteristics; and displaying the particular presentation of the text for user adaptation.

11. A method as claimed in claim 1, wherein the speech synthesizer command constrains operation of the speech synthesizer.

12. A method as claimed in claim 1, wherein the text of the advertising copy is comprised of phrases and the speech synthesizer command forces a rendition of at least one phrase within the text.

13. A method as claimed in claim 1, wherein the speech synthesizer command mandates a particular audio feature in the synthesized speech.

14. An apparatus comprising:
a display for displaying advertising copy text;
a user input device for adapting audio features that are visually associated with the advertising copy text;
a processor for creating voice synthesizer commands that depend upon the advertising copy text and the adapted audio features; and
an audio output device for outputting speech synthesized by a voice synthesizer.

15. An apparatus as claimed in claim 14, wherein the user input device enables user adaptation of a presentation of the displayed advertising copy text, the speech synthesizer command depends upon the textual content of the displayed advertising copy and also upon the presentation of the advertising copy text and wherein the audio output device is operable to render the advertising copy text as speech with characteristics that are dependent upon the presentation of the advertising copy text.

16. An apparatus as claimed in claim 15, wherein the processor is operable to receive from the voice synthesizer mark up text representing synthesized speech; to convert the mark up text into a particular presentation of the text that represents the synthesized speech and its characteristics; and to control display of the particular presentation of the text for user adaptation.

17. A method of manufacturing an aural advertisement comprising:
receiving advertising copy; and
performing speech synthesis of the advertising copy to produce and record a data structure that is operable to control an audio device to render the advertising copy as synthesized speech.

18. A method as claimed in claim 17 further comprising rendering the data structure as synthesized speech as part of an advertisement.
